(19) United States
(12) Patent Application Publication
(10) Pub. No.: US 2024/0370229 A1
(43) Pub. Date: Nov. 7, 2024

(54) MULTI-LANE CRYPTOGRAPHIC ENGINES WITH SYSTOLIC ARCHITECTURE AND OPERATIONS THEREOF

(71) Applicant: CRYPTOGRAPHY RESEARCH, INC., San Jose, CA (US)

(72) Inventors: Michael Alexander Hamburg, ‘s-Hertogenbosch (NL); Arvind Singh, Dublin, CA (US)

(21) Appl. No.: 18/290,720

(22) PCT Filed: Jul. 14, 2022
(86) PCT No.: PCT/US2022/037206

§ 371 Date: Jan. 19, 2024

Related U.S. Application Data
(60) Provisional application No. 63/203,469, filed on Jul. 23, 2021.

(51) Int. Cl. G06F 7/544; G06F 5/06; G06F 7/72

(52) U.S. Cl. CPC G06F 7/5443; G06F 5/06; G06F 7/728

(57) ABSTRACT

Aspects of the present disclosure involve a cryptographic processor that includes a systolic array having a plurality of processing lanes (PLs), each PL including a systolic sub-array of two or more processing elements (PEs), each PE being configured to multiply two numbers to obtain and store a multiplication product. The cryptographic processor is configured to efficiently perform a variety of operations, including multiplication of large numbers, modular reduction, Montgomery reduction, and the like.

### RELATED APPLICATIONS

This application is a 371 application of International Application No. PCT/US2022/037206, filed Jul. 14, 2022, which claims the benefit of U.S. Provisional Patent Application No. 63/203,469, filed Jul. 23, 2021, which is incorporated herein by reference.

### TECHNICAL FIELD

The disclosure pertains to cryptographic computing applications and, more specifically, to improving efficiency of cryptographic operations with cryptographic engines having systolic processing arrays capable of performing parallel and streaming computations.

### BRIEF DESCRIPTION OF THE DRAWINGS

The present disclosure will be understood more fully from the detailed description given below and from the accompanying drawings of various implementations of the disclosure.

FIG. 1 is a block diagram illustrating an example system architecture in which implementations of the present disclosure may operate.

FIG. 2 is a block diagram illustrating an example cryptographic engine operating in accordance with some implementations of the present disclosure.

FIG. 3 is a block diagram illustrating an architecture of an example processing element of a cryptographic engine operating in accordance with some implementations of the present disclosure.

FIG. 4A is a diagram illustrating one example implementation of a multiplication operation performed by multiple lanes of a cryptographic engine operating in accordance with some aspects of the present disclosure.

FIG. 4B is a diagram illustrating one example implementation of multiplication operations performed in parallel by different processing lanes, in accordance with some aspects of the present disclosure.

FIG. 5A is a diagram illustrating one example implementation of a Montgomery reduction performed in connection with a multiplication operation by a cryptographic engine operating in accordance with some aspects of the present disclosure.

FIG. 5B is a diagram illustrating another example implementation of a Montgomery reduction performed in connection with a multiplication operation by a cryptographic engine operating in accordance with some aspects of the present disclosure.

FIG. 6 is a flow diagram depicting method of a multiplication performed on a cryptographic processor that has a systolic array of processing elements and operates in accordance with one or more aspects of the present disclosure.

FIG. 7 is a flow diagram depicting method of a Montgomery reduction performed on a cryptographic processor that has a systolic array of processing elements and operates in accordance with one or more aspects of the present disclosure.

FIG. 8 depicts a block diagram of an example computer system operating in accordance with one or more aspects of the present disclosure.

### DETAILED DESCRIPTION

Aspects of the present disclosure are directed to cryptographic engines and methods of using said cryptographic engines for improving computational efficiency and memory utilization in cryptographic operations that include, but are not limited to, public-key cryptography applications. More specifically, aspects of the present disclosure are directed to multi-lane cryptographic engines with systolic architecture for efficient multiplication of numbers of various sizes, modular multiplication, Montgomery multiplication and reduction, and other operations used in cryptographic applications.

Various cryptographic computations may involve operations that are efficiently performed by offloading them from a main processor to a dedicated cryptographic engine (accelerator) that includes hardware circuits designed to improve speed and efficiency of arithmetic operations (multiplication, division, addition, etc.) and memory accesses. For example, in Rivest-Shamir-Adelman (RSA) public key/private key applications, large prime numbers p and q may be selected to generate a pair of a public (encryption) exponent e and a secret (decryption) exponent d such that e and d are inverse of each other modulo a certain number (e.g., modulo (p−1). (q−1) or a lowest common multiplier of p−1 and q−1). The numbers e and N=p·q are revealed as part of the public key while p, q, and d are stored in secret as parts of the private key. A message m may be encrypted into a ciphertext c using modular exponentiation, c=m^{e} mod N, and can be deciphered using another modular exponentiation, m=c^{d} mod N, based on the private exponent d. To prevent unauthorized actors from recovering the private exponent d, the prime multipliers p and q are typically selected to be large numbers, e.g., 1024-bit numbers.

Some applications use elliptic curve cryptography that involves operations with points (x,y) on an elliptic curve, e.g., an elliptic Weierstrass curve, y²=x³+ax+b. Arithmetic operations (such as addition, doubling, and infinity operations) are defined via a set of geometric rules; e.g., a sum of three points on an elliptic curve is zero, P₁+P₂+P₃=0, if the points P₁, P₂, P₃ are located at the intersection of the elliptic curve with a straight line. The strength of the elliptic curve cryptography is based on the fact that for large values of k, a product Q=P·k can be practically anywhere on the elliptic curve. As a result, the inverse operation to determine an unknown value of (e.g., private key) k from a known public value Q can be a prohibitively difficult computational operation. In elliptic curve cryptography, it is typically sufficient to use numbers that are much smaller (e.g., 256-bit numbers) than numbers used in RSA applications.

Decryption and encryption operations often require a large number of arithmetic operations being performed, which may take many clock cycles, especially when performed on low-bit microprocessors, such as smart card readers, wireless sensor nodes, and so on. Cryptographic engines (accelerators, co-processors) are specially designed collections of circuits that execute specialized computationally intensive cryptographic operations more efficiently than a general purpose processor (e.g., a central processing unit). Because in many applications (including network and cloud applications) cryptographic operations may constitute a significant portion of the total computational load, small and efficient cryptographic engines are highly desired.

In applications, cryptographic engines are often called on to operate on numbers of different sizes. For example, the same cryptographic engine may provide computational support for cryptographic applications that use the RSA algorithm (with large, e.g., 1024-bit inputs) whereas other applications use ECC algorithms (with smaller, e.g., 256-bit inputs). Multiplication of large numbers may be more efficiently performed by splitting large numbers into segments (words) and multiplying the large numbers word by word with accumulator values and carries propagated through various word multiplications, e.g., as in the schoolbook algorithm. For example, two 1024-bit input numbers X and Y may be segmented into sets of sixteen 64-bit words {Xⱼ} and {Yⱼ} and processed through sixteen multiplication circuits connected into a systolic array, each word of the multiplier Xⱼ being handled by a specific multiplication circuit and each word of the multiplicand Yₖ streamed into and out of each (and into the next) multiplication circuit. When smaller, e.g., 256-bit, numbers are processed by such an array of multiplication circuits, the multiplication operations may be complete by the first four multiplication circuits, but the data may still have to be streamed through the remaining twelve multiplication circuits. Such streaming slows down the speed of the computations, makes the pass-through circuits unavailable for other multiplication operations, and increases power consumption.

Described in the instant disclosure are cryptographic engines that allow increased flexibility in handling multiplications (and other operations) of numbers of different sizes. Described herein is a segmented systolic array (SSA) having multiple processing elements, e.g., computational units that may include multiplication circuits, addition circuits, memory buffers, and other components (such as special prime units). The systolic array may be partitioned into multiple (e.g., N) processing lanes having multiple (e.g., n) processing elements. Each processing lane may have an independent data input and data output. Each processing lane may receive data input directly from a preceding lane and provide data output directly into a subsequent lane. Each processing lane may have a control unit that can configure operations performed by the respective lane and a buffer that can store outputs of the lane in the instances where the outputs are to be used by a subsequent lane while the subsequent lane is finishing ongoing operations. Also described are example operations, e.g., multiplications, modular multiplications, Montgomery reductions, which may be performed on a SSA (although various other operations can also be performed using the disclosed SSA). For example, multiplication of small (e.g., 256-bit) numbers may be handled by a single processing lane, which may output and store the obtained results without affecting processing by other processing lanes. Multiplication of larger (e.g., 512-bit or 1024-bit) numbers may be performed by multiple processing lanes, e.g., two, three, or more adjacent processing lanes.

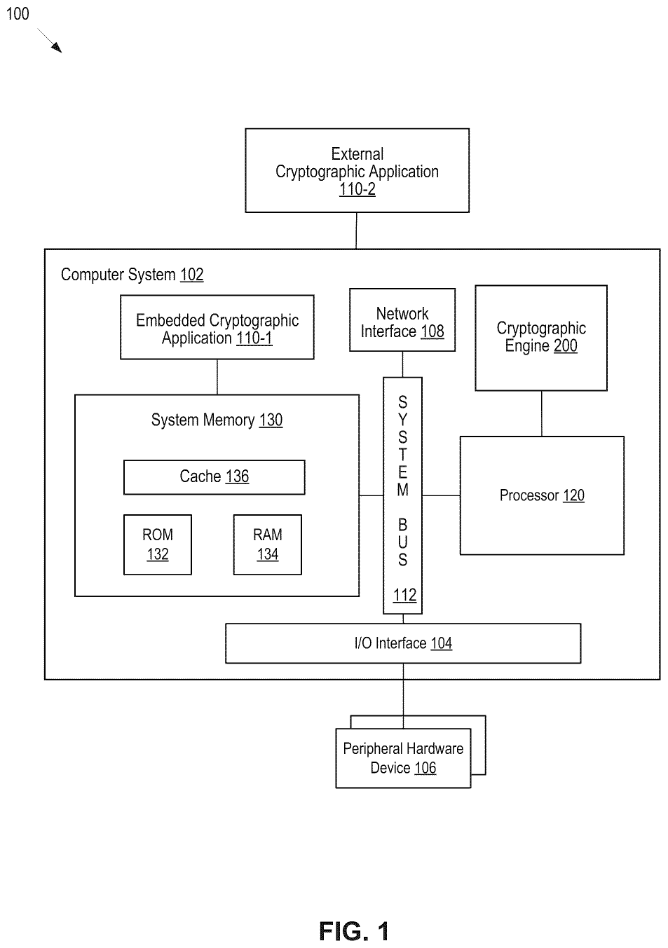

FIG. 1 is a block diagram illustrating an example system architecture 100 in which implementations of the present disclosure may operate. The example system architecture 100 may be a desktop computer, a tablet, a smartphone, a server (local or remote), a thin/lean client, and the like. The example system architecture 100 may be a smart a card reader, a wireless sensor node, an embedded system dedicated to one or more specific applications (e.g., cryptographic applications 110-1 and 110-2), and so on. The system architecture 100 may include, but need not be limited to, a computer system 102 having one or more processors 120, e.g., central processing units (CPUs) capable of executing binary instructions, and one or more memory devices 130. “Processor,” as used herein, refers to a device capable of executing instructions encoding arithmetic, logical, or I/O operations. In one illustrative example, a processor may follow Von Neumann architectural model and may include one or more arithmetic logic units (ALUs), a control unit, and a plurality of registers.

The system architecture 100 may further include an input/output (I/O) interface 104 to facilitate connection of the computer system 102 to peripheral hardware devices 106 such as card readers, terminals, printers, scanners, internet-of-things devices, and the like. The system architecture 100 may further include a network interface 108 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computer system 102. Various hardware components of the computer system 102 may be connected via a system bus 112 that may include its own logic circuits, e.g., a bus interface logic unit (not shown).

The computer system 102 may support one or more cryptographic applications 110-n, such as an embedded cryptographic application 110-1 and/or external cryptographic application 110-2. The cryptographic applications 110-n may be secure authentication applications, encrypting applications, decrypting applications, secure storage applications, and so on. The external cryptographic application 110-2 may be instantiated on the same computer system 102, e.g., by an operating system executed by the processor 120 and residing in the memory device 130. Alternatively, the external cryptographic application 110-2 may be instantiated by a guest operating system supported by a virtual machine monitor (hypervisor) executed by the processor 120. In some implementations, the external cryptographic application 110-2 may reside on a remote access client device or a remote server (not shown), with the computer system 102 providing cryptographic support for the client device and/or the remote server.

The processor 120 may include one or more processor cores having access to a single-level or multi-level cache and one or more hardware registers. In implementations, each processor core may execute instructions to run a number of hardware threads, also known as logical processors. Various logical processors (or processor cores) may be assigned to one or more cryptographic applications 110, although more than one processor core (or a logical processor) may be assigned to a single cryptographic application for parallel processing. A multi-core processor 120 may simultaneously execute multiple instructions. A single-core processor 120 may typically execute one instruction at a time (or process a single pipeline of instructions). The processor 120 may be implemented as a single integrated circuit, two or more integrated circuits, or may be a component of a multi-chip module.

The memory device 130 may refer to a volatile or non-volatile memory and may include a read-only memory (ROM) 132, a random-access memory (RAM) 134, high-speed cache 136, as well as (not shown) electrically erasable programmable read-only memory (EEPROM), flash memory, flip-flop memory, or any other device capable of storing data. The RAM 134 may be a dynamic random-access memory (DRAM), synchronous DRAM (SDRAM), a static memory, such as static random-access memory (SRAM), and the like. Some of the cache 136 may be implemented as part of the hardware registers of the processor 120. In some implementations, the processor 120 and the memory device 130 may be implemented as a single field-programmable gate array (FPGA).

The computer system 102 may include a cryptographic engine 200 for fast and efficient performance of cryptographic computations, as described in more detail below. Cryptographic engine 200 may include processing and memory components, as described in more detail below. Cryptographic engine 200 may facilitate exchange of secret data, authentication of applications, users, access requests, and the like, in association with operations of the cryptographic applications 110-n or any other applications operating on or in conjunction with the computer system 102. Cryptographic engine 200 may further perform encryption and decryption of secret information.

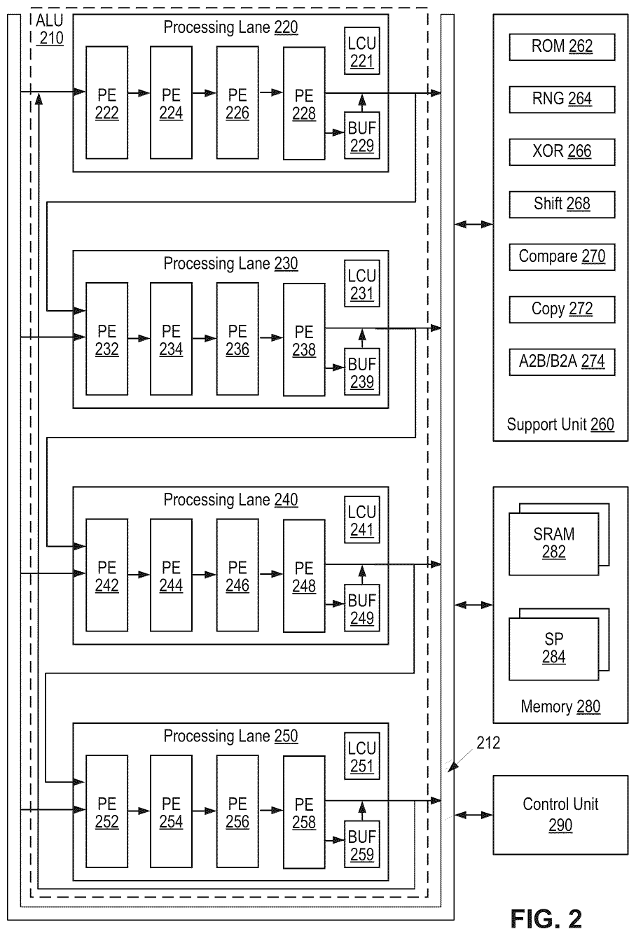

FIG. 2 is a block diagram illustrating an example cryptographic engine 200 operating in accordance with some implementations of the present disclosure. Cryptographic engine 200 may include an arithmetic logic unit (ALU) 210 having a number of processing lanes (PLs). For conciseness, shown are four PLs. e.g., PL 220, PL 230, PL 240, and PL 250, even though ALU 210 may include any number N of processing lanes (e.g., more or less than four). ALU 210 may also have a number of addition units (not explicitly shown in FIG. 2) that may perform addition and subtraction operations (e.g., using outputs of the processing lanes as well as numbers loaded from memory). In addition, each processing lane may include internal addition units to perform addition and subtraction operations using inputs, outputs, and any intermediate values obtained by a respective processing lane or passed from other processing lanes.

Each processing lane may include a number of processing elements (PE). For conciseness, shown are four PEs within each processing lane, even though processing lane may have any number n of processing elements (e.g., more or less than four). For example, as depicted, PL 220 includes PE 222, PE 224, PE 226, and PE 228; PL 230 includes PE 232, PE 234, PE 236, and PE 238; PL 240 includes PE 242, PE 244, PE 246, and PE 248; and PL 250 includes PE 252, PE 254, PE 256, and PE 258. Each processing element may be capable of performing a multiplication on a k-bit multiplier and an l-bit multiplicand (also referred herein as words). For example, in one implementation, k=l=64. In another implementation, k=32 and l=64. A word upon which a processing element operates may be a complete number or a portion of a larger number that is being processed (concurrently and/or sequentially, as described in more detail below) by multiple processing elements and multiple processing lanes. Unidirectional solid arrows in FIG. 2 indicate the direction of data flow in the cryptographic engine. Communication of data to and from processing elements may be facilitated by bus 212. Bus 212 may provide inputs into any of the processing elements from memory 280 and may receive outputs from any of the processing lanes (e.g., for delivery to memory 280). In some implementations, the SSA of the cryptographic engine 200 may be a circular systolic array, with the last PL 250 capable of providing outputs directly to the first PL 220 (without assistance of bus 212), for faster processing. For example, during multiplication of a 1024-bit number by a 2048-bit number, the cryptographic engine may use two full runs around PLs 220-250 with first sixteen 64-bit multiplicand words processed during the first run and second sixteen 64-bit multiplicand words processed during the second run. (Each PE may operate on the same sixteen 64-bit multiplier word during both runs.)

As depicted, each processing lane may receive input data from bus 212 and output data into bus 212. Data received by a first processing element of each processing lane be processed and passed to the next processing element of the same processing lane. Although not depicted (for the sake of reader's convenience), data may be received by any of the subsequent processing elements directly from bus 212, and not only from a preceding processing element. For example, during a first cycle of computations, data may be received by PE 222 of PL 220 from bus 212. The received data may include a word of a multiplier X and a word of a multiplicand Y. PE 222 may perform multiplication (in some implementations, modular multiplication) of the received words and store a low word of the product in an accumulator circuit (e.g., buffer) while passing a high (carry) word to the next processing element, e.g., PE 224. PE 222 may additionally pass the used multiplicand word to the downstream PE 224. During the next cycle, PE 224 may receive from bus 212 a new word of the multiplicand and multiply the previously received word of the multiplier by the new word of the multiplicand. In the meantime, PE 224 may load the next word of the multiplier X and multiply the loaded word of the multiplier by the word of the multiplicand passed by PE 222. Other processing elements of PL 220 may operate in a similar fashion by streaming data (e.g., multiplicand words, accumulator values, carry values, etc.) to downstream processing elements, with words of the multipliers loaded and retained by various processing elements and words of the multiplicands loaded by an upstream processing elements and passed to downstream processing elements. In some implementations, words of both the multiplier and the multiplicand may be loaded from memory prior to each cycle of computations.

Some or all processing lanes may include a lane buffer for temporary storage of outputs. For example, PL 220 may include lane buffer 229; PL 230 may include lane buffer 239; PL 240 may include lane buffer 249; and PL 250 may include lane buffer 259. Lane buffers may be utilized when the output of a processing lane is used as an input into the next processing lane (e.g., output of PL220 used as an input into PL 230) rather than stored in memory 280, for example, in instances where the next processing lane is finishing a previous computation and is not yet ready to process inputs from the preceding lane.

Some or all processing lanes may include a lane control unit (LCU) for controlling operations within the respective processing lane and directing data flow between various processing elements and other components of the lane. For example, PL 220 may include LCU 221; PL 230 may include LCU 231; PL 240 may include LCU 241; and PL 250 may include LCU 251. For example, LCU 221 may determine that PL 220 is to multiply a first 128-bit number by a second 128-bit number and may only use PE 222 and PE 224 for the multiplication operations (on 64-bit operands) while designating PE 226 and PE 228 as pass-through elements. On the other hand, LCU 231 may determine that PL 230 is to multiply a third 256-bit number by a fourth 256-bit number and may use all four PEs of PL 230 for the respective multiplication operations.

Memory 280 of cryptographic engine 200 may include a number of memory units (circuits), such as any number of static random-access memory (SRAM) units 282 and any number of scratchpad (SP) units 284. Each SRAM 282 may be a single-port memory unit configure to load one word or store one word, per cycle. Each SP unit 284 may be a two-port memory unit configured to load one number and store one number, per cycle.

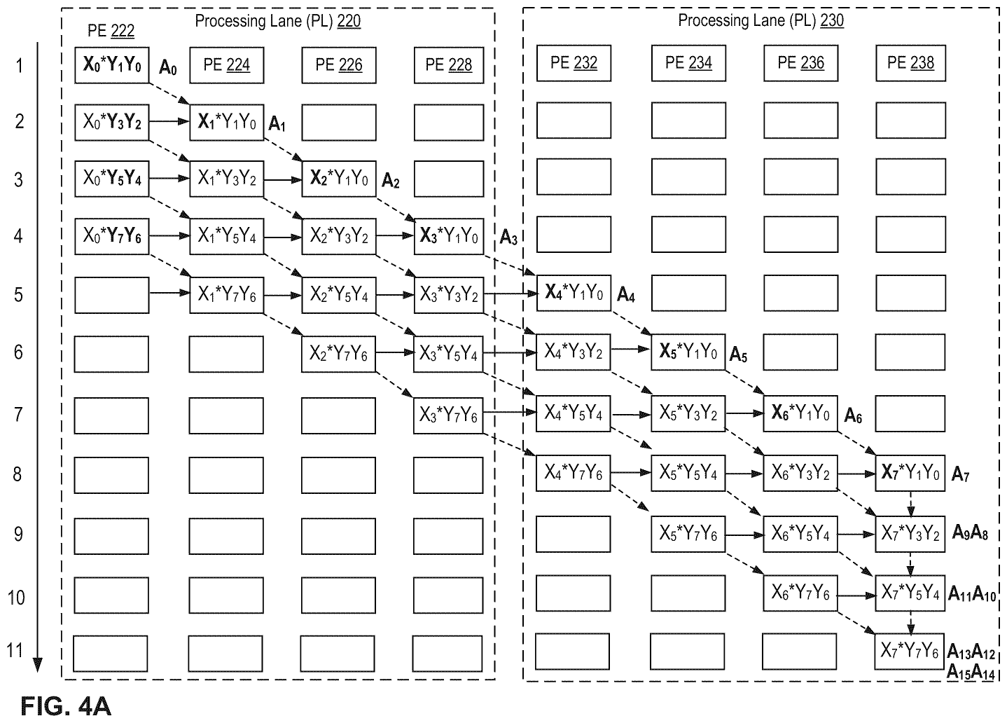

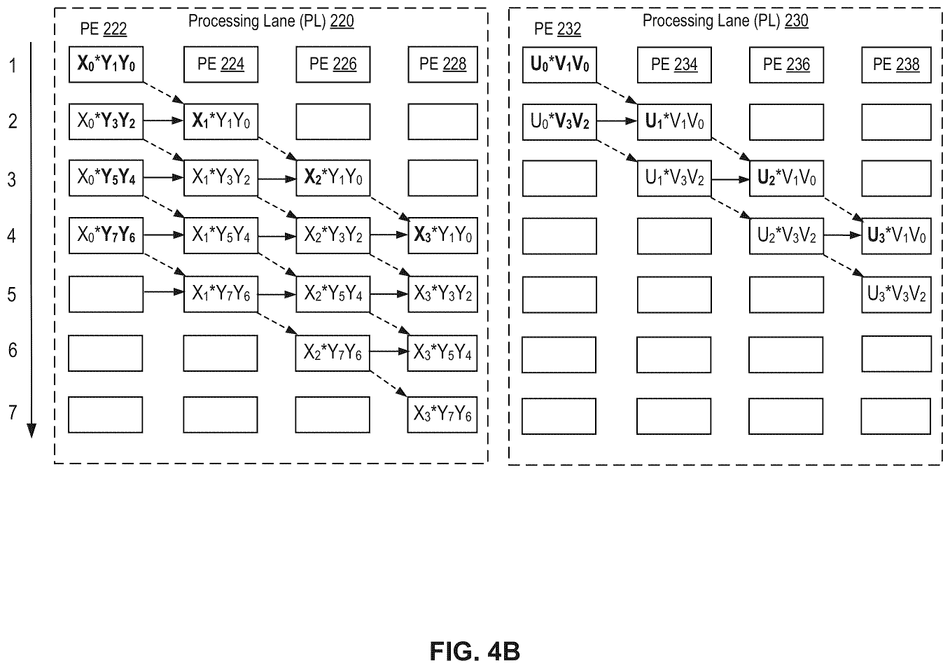

Bus 212 may include a number of data communication lines (data bus) for transferring data (input and output numbers) between the aforementioned components of cryptographic engine. Additionally, bus 212 may include an address bus for communicating signals that identify source and destination of data. Bus 212 may also include a control bus, e.g., lines for communicating control signals from a control unit 290. Control unit 290 may include a clock to maintain cycles of computations and memory access operations. Control unit 290 may store instructions to the cryptographic engine to perform various cryptographic computations. Control unit 290 may determine which processing lanes are to perform a particular operation and may further determine an order of such operations. For example, control unit 290 may identify that cryptographic engine 200 is to perform a multiplication of two 512-bit numbers and direct PL 220 and PL 230 to perform the multiplication, while PL 240 and PL 250 may remain idle (or perform multiplications of some other numbers). As another example, control unit 290 may identify that cryptographic engine 200 is to perform a multiplication of two 1024-bit numbers and direct all four PLs 220-250 to perform the multiplication. As another example, control unit 290 may determine that PL 220 and PL 240 are to perform multiplications while PL 230 and PL 250 are to perform Montgomery reduction of the outputs of PL 220 and PL 240, as described in more detail below in relation to FIG. 4A and FIG. 4B. In some implementations, control unit 290 may be programmable (e.g., by an external processor, such as processor 120 of FIG. 1).

An additional ALU support unit 260 may include circuits that perform operations different from multiplications or additions. ALU support unit 260 may include a read-only memory (ROM) 262, which may store constants (such as modulus p, auxiliary number s Montgomery radix R, inverse radix, R⁻¹ mod p, various other auxiliary numbers, such as powers of radix R, e.g., R² mod p or modulo some other suitable modulus, etc.) and various instructions to be used by control unit 290, and so on. ALU support unit 260 may further include a random number generator (RNG) 264 for generation of random (or pseudorandom) numbers, an XOR unit 266 for performing XOR operations, a shift unit 268 to perform bit shifting and bit masking, a compare unit 270 to perform comparison of input numbers, a copy unit 272 for copying numbers, an A2B/B2A unit 274, as well as any other auxiliary units (circuits) performing a function that may be used in operations of the cryptographic engine 200.

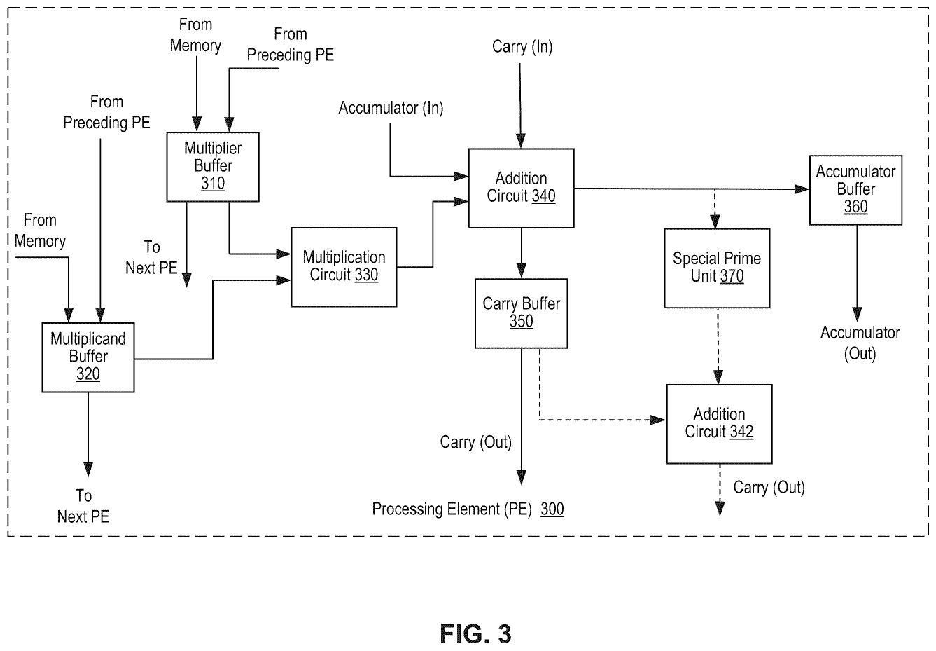

FIG. 3 is a block diagram illustrating an architecture of an example processing element 300 of the cryptographic engine 200 operating in accordance with some implementations of the present disclosure. Processing element 300 may be any one of the processing elements of FIG. 2, e.g., any one of PEs 222-258. Processing element 300 may include a multiplier buffer 310 to store a word of a multiplier X and a multiplicand buffer 320 to store a word of a multiplicand Y. In some implementations, multiplier buffer 310 receives multiplier words from memory and stores the received inputs for multiple multiplication operations (e.g., until all words of multiplicand are processed by processing element 300). Multiplicand buffer 320 may receive a multiplicand word from memory (e.g., during the first time the multiplicand word is used by the cryptographic engine) or from a preceding processing element. Although not explicitly depicted, in some implementations, words of multiplier may similarly be passed to multiplier buffer 310 from one of preceding processing elements.

A multiplication circuit 330 may process the received words of the multiplier and multiplicand. If a word of the multiplier has m bits and the word of the multiplicand has M bits, the output of multiplication circuit 330 may be an (M+m)-bit word. An addition circuit 340 may process the output of multiplication circuit 330 and may further add an accumulator (“accumulator in”) and a carry (“carry in”) from one or more of the preceding circuits. The resulting (M+m)-bit word may be split between a carry buffer 350 (which may be a flip-flop memory or any other suitable memory device) and an accumulator buffer. For example, the high M-bit word of the result may be stored in carry buffer 350 while the low m-bit word of the result may be stored in an accumulator buffer 360. The content of accumulator buffer 360 may then be passed on (e.g., at the beginning of the next computational cycle) to a next processing element that processes the words of the same significance. The content of carry buffer 350 may be passed on (“carry out”) to a processing element that processes words of a higher significance, as described in more detail below in relation to FIG. 4A and FIG. 4B.

In some implementations, an operation performed by cryptographic engine 200 may be a modular multiplication that uses one of special prime moduli p, such as one of Solinas primes (e.g., p=2¹⁹²−2⁶⁴−1, p=2³⁸⁴−2¹²⁸−2⁹⁶+2³²−1), Mersenne primes, Crandall primes, and other simple primes. In such implementations, as depicted with dashed arrows, modular reduction may be performed for each word of the result (product) without waiting for other words of higher significance to be processed. For example, the last processing element that completes computations of the k-th least significant word of the result, may perform modular reduction of said word using a special prime unit 370. Special prime values p are represented by bits of 0 that are separated by 31 or more bits of 0. As a result, modular reduction may be performed with one of the known algorithms that use several additions and subtractions, which may be implemented with addition circuits and shifting circuits (e.g., linear feedback shift register) that are part of special prime unit 370. An output of modular reduction performed by special prime unit 370 may be added by an addition circuit 342 and output as a new carry value. In those instances where processing element 300 computes an intermediate value of a word of the result, output data may be directed to accumulator buffer 360 and used in the next cycle (e.g., by other processing elements).

FIG. 4A is a diagram illustrating one example implementation of a multiplication operation performed by multiple lanes of the cryptographic engine 200 operating in accordance with some aspects of the present disclosure. Depicted in FIG. 4A are multiplications performed by various processing elements of PL 220 and PL 230. Shown are consecutive cycles of computations indicated by the numerals next to the vertical axis. Multiplications performed by various processing elements in consecutive cycles correspond to the same columns in FIG. 4A. For example, the first column in PL 220 box corresponds to operations of PE 222, the second column corresponds to operations of PE 224, and so on.

For the sake of illustration but not limitation, operations depicted in FIG. 4A involve processing of eight m-bit words of multiplier X and eight M-bit words of multiplicand Y with one word of the multiplier multiplied each time by two words of the multiplicand (gear ratio 1:2), for example m=32 bits of multiplier are multiplied by 2M=64 bits (two words) of multiplicand. The same illustration applies when m=64-bits of multiplier are multiplied each time by 2M=128 bits of the multiplicand, or any other word sizes. The multiplier is shorthanded schematically as X=X₇X₆X₅X₄X₃X₂X₁X₀, with X₀ denoting m least significant bits and X₇ denoting m most significant bits of X. In other words, for the multiplier, X=X₀r⁰+X₁r¹+X₂r²+ . . . , where r=2^{m} is the base number. A similar notation is used for the multiplicand (assuming m=M for simplicity of illustration):=Y₀r⁰+Y₁r¹+Y₂r²+ . . . =(Y₀+Y₁r)r⁰+(Y₂+Y₃r)r²+ . . . . Accordingly, the product

$$A = X \cdot Y = {X}_{0} ( {Y}_{0} + {Y}_{1} r ) {r}^{0} + {X}_{1} ( {Y}_{0} + {Y}_{1} r ) {r}^{2} + {X}_{0} ( {Y}_{2} + {Y}_{3} r ) {r}^{2} + {{X}_{2} ( {Y}_{0} + {Y}_{1} r )}^{2} + {X}_{1} ( {Y}_{2} + {Y}_{3} r ) {r}^{3} + {X}_{3} ( {Y}_{0} + {Y}_{1} r ) {r}^{3} + ⋯$$

is, generally, a 16-word number A=A₁₅ . . . A₀, each word having m bits.

The following notations are used in FIG. 4A to indicate the above described operations. The words that are loaded in conjunction with a respective multiplication performed by various PEs are indicated with bolded letters inside the respective boxes while the multiplier/multiplicand words that are reused (passed between different PEs) are indicated with normal letters. Dashed lines indicate passage of 1) previously loaded words of the multiplicand and 2) previously computed carries. As encountered during later cycles, vertical dashed arrows indicate passage of previously computed carries (without passing the words of the multiplicand). Horizontal solid arrows depict passage of a (low word) accumulator value after computing a product indicated inside the respective box (where the solid arrow begins).

During cycle 1, PE 222 may receive the low (least significant) word X₀ of multiplier, and two low words Y₁Y₀ of multiplicand, and compute the product X₀·Y₁Y₀, which is (generally) a three-word number. The low word of X₀·Y₁Y₀ represents the low word A₀ of the product A and may be stored in one of memory units (as depicted schematically by symbol A₀ next to PE 222 box in cycle 1). The high two words of the product X₀·Y₁Y₀ may be stored (buffered) in PE 222 as a carry (e.g., in carry buffer 350 in FIG. 3) into the operations of the next cycle.

During cycle 2, PE 222 may provide the stored carry and two low words Y₁Y₀ of the multiplicand to PE 224, load the next two words Y₃Y₂ of the multiplicand, and multiply the previously loaded low word X₀ of the multiplier by the new words Y₃Y₂ of the multiplicand. PE 222 may then compute X₀·Y₃Y₂, buffer a new carry (two high words of X₀·Y₃Y₂) until the next cycle (e.g., in accumulator buffer 360) and provide the accumulator value (the low word of X₀·Y₃Y₂) to PE 224 (as indicated by the solid arrow). Additionally, during the same cycle 2, PE 224 may load the next word X₁ of the multiplier from the memory and receive two words Y₁Y₀ of the multiplicand from PE 222 (as well as the respective carry), as depicted schematically with the dashed arrow. PE 224 may further receive the accumulator value computed by PE 222 during the same cycle 2. PE 224 may then add the received two-word carry and one-word accumulator to the computed product X₁·Y₁Y₀. PE 224 may buffer the high two words of the obtained result as the next carry (to be passed on to PE 226 in cycle 3), and may store a low word A₁ of the result as the next word of the product A. In some implementations, the addition operation performed by PE 224 may be done by a multi-way addition circuit (e.g., addition circuit 340) capable of adding more than two numbers per cycle; e.g., adding X₁·Y₁Y₀+carry+accumulator value in one operation. In some implementations, the addition unit may be configured to perform multiple consecutive additions of two numbers over one cycle, e.g., obtaining a first sum X₁·Y₁Y₀+carry during the first operation and then adding the accumulator value to the first sum during the second operation (or in any other order).

Similar streaming computations may be performed in subsequent cycles, as depicted. In cycle k, PE 222 passes two words Y₂ₖ₋₃Y₂ₖ₋₄ of the multiplicand (loaded during cycle k−1) and one-word carry (computed during cycle k−1) to PE 224 and loads the next two words Y₂ₖ₋₁Y₂ₖ₋₂ of the multiplicand. Similarly, other PEs pass previously processed multiplicand words (and computed carries) to the next PE. In addition, during cycle k≤M, loads the multiplier word Xₖ₋₁ from memory and multiplies it by Y₁Y₀. During cycle k, products Xⱼ·Y₂ₖ₋₂ⱼ₋₁Y₂ₖ₋₂ⱼ₋₂ with different j are computed by different PEs. Because there are twice as many words of the multiplier to load as there are PEs in PL 220, computations do not stop after the processing reaches the last PE 228 of PL 220. For the next three cycles, computations are shared by PL 220 and PL 230, with multiplicand words, accumulators, and carries streamed from PL 220 to PL 230. Starting from cycle 8, processing is performed solely by PL 230.

At the end of each cycle k≤8, the word Aₖ₋₁ of the product A is determined (and stored in one of the memory circuits). At the end of cycle k>8, the low word of the result of multiplication X₇·Y₃Y₂ (plus the received carry and accumulator value) may be passed to an addition circuit that may add the carry from the last block of cycle 8 (as depicted by the downward dashed arrow). The low two words of the sum represent the words A₉A₈ of the final product A and are stored in memory (e.g., together with previously computed words Aⱼ). The high word of the sum is retained in the addition circuit. At the end of each subsequent cycle, the addition circuit adds a new two-word carry from the previous cycle (vertical dashed arrows) and a new one-word accumulator (horizontal solid arrows) to the previously stored high word, identifies the new two low words as the next two words of the final product A and so on. After cycle 11 (upon computing the last multiplication X₇·Y₇Y₆) both the high word and the low word of the last addition operation are stored as the last two words of the final product, A₁₅A₁₄.

In the example illustrated in FIG. 4A, 2m bits of multiplicand Y and m bits of multiplier X are loaded every cycle (until all bits of the multiplier and multiplicand are loaded). In some implementations, equal portions of each of the multiplier and the multiplicand may be loaded. For example, while 2m bits of multiplicand Y may be loaded every cycle, the same number of 2m bits of multiplier X may be loaded every odd cycle. More specifically, during cycle 1, m-bit word X₀ of the multiplier is loaded into PE 222 and another m-bit word X₁ of the multiplier is loaded into PE 222 (where it remains unused until cycle 2). Similarly, during cycle 3, m-bit word X₂ of the multiplier is loaded into PE 226 and another m-bit word X₄ of the multiplier is loaded into PE 228 (where it remains unused until cycle 4).

As depicted in FIG. 4A with empty blocks, some of the processing elements are idle during early cycles and some processing elements are idle during late cycles. Idling PEs may be used to compute products of other numbers, in a pipelined fashion. For example, once PE 222 becomes available (after cycle k=4 is compete), PE 222 is ready to load low words of an additional multiplier and multiplicand (e.g., U₀ and V₀) that are to be multiplied next. The process then continues for the new multiplier and multiplicand substantially as described above.

Operations illustrated in FIG. 4A are performed by processing lanes that have n=m processing elements and involve numbers having M=2m words of multiplier X (with m=4). As a result, the operations are handled by two processing lanes. Similarly, N lanes with n processing elements each can perform one single multiplication operation that involves a multiplier with N·n words in a streaming fashion using the number of cycles that is determined by the number of words of the multiplicand (which can be arbitrary). Alternatively, N lanes with n processing elements each can perform N′ parallel multiplication operations with N·n/N′ processing elements deployed in each multiplication operation (e.g., each operation having N·n/N′-word multipliers and arbitrary multiplicands). FIG. 4B is a diagram illustrating one example implementation of multiplication operations performed in parallel by different processing lanes, in accordance with some aspects of the present disclosure. Depicted in FIG. 4B is an instance where two multipliers X and U of m words each (a case of m=4 is depicted) are handled by PL 220 and PL 230. PL 220 performs multiplication X·Y with 2m-word multiplicand Y and PL 230 performs multiplication U·V with m-word multiplicand V, with the operations of PL 220 taking two cycles longer than operations of PL 230. As described above, empty boxes indicate instances of PEs not being active in the depicted operations, and when the respective PEs can be used for pipelined processing of other multiplication operations. For example, empty boxes at the top right corner of each dashed box correspond to operations that can be performed on earlier pipelined inputs into PL 220 and PL 230 whereas empty boxes at the bottom left corner correspond to operations that can be performed on later pipelined inputs.

The systolic array architecture illustrated in FIG. 4A and FIG. 4B uses a 1:2 gear ratio processing, where during each cycle, a processing element multiplies one word of the multiplier X by two words of the multiplicand Y. Correspondingly, one word of the multiplier and two words of the multiplicand may be loaded per cycle, until all words of the multiplier or multiplicand are loaded. This may be advantageous in situations where at least some of the units of memory 280 are capable of providing unequal number of words of different numbers per cycle. In some systems, the memory may be configured to provide equal number of words, so that the words of the multiplier X may, therefore, also be provided in pairs, e.g., two words every second cycle. In such systems, additional data control may be used to ensure that streams of multiplier and multiplicand words (having different data rates) are properly coordinated and that preloaded multiplier words (still awaiting processing) are properly buffered.

For example, in a synchronous memory access system, in which equal number of words of multiplicand and multiplier are loaded, each processing element may include (or have access to) a synchronizer buffer (not shown in FIG. 2). In some implementations, the synchronizer buffer may be a buffer that stores one word of multiplier. The buffer may be implemented as a shift register. The multiplier words may be loaded into the first processing elements (e.g., PE 222 and PE 224) and passed along the systolic array to other processing elements, as illustrated in the following timing table.

TABLE 1
Example data flow in a systolic array with operand buffering

| | Buffer | | Buffer | | Buffer | | Buffer | |
|---|---|---|---|---|---|---|---|---|
| Cycle | (PE 222) | PE 222 | (PE 224) | PE 224 | (PE 226) | PE 226 | (PE 228) | PE 228 |
| 1 | X₀ | X₀ · Y₁Y₀ | X₁ | | | | | |
| 2 | X₂ | X₀ · Y₃Y₂ | X₃ | X₁ · Y₁Y₀ | [X₀] | | [X₁] | |
| 3 | X₄ | X₀ · Y₅Y₄ | X₅ | X₁ · Y₃Y₂ | X₂ | X₂ · Y₁Y₀ | X₃ | |
| 4 | X₆ | X₀ · Y₇Y₆ | X₇ | X₁ · Y₅Y₄ | X₄ | X₂ · Y₃Y₂ | X₅ | X₃ · Y₁Y₀ |
| 5 | . . . | . . . | . . . | X₂ · Y₇Y₆ | X₆ | X₂ · Y₅Y₄ | X₇ | X₃ · Y₃Y₂ |

As can be seen from Table 1, during cycle 1, multiplier word Xo is loaded into buffer of PE 222, multiplier word X₁ is loaded into buffer of PE 224, and multiplicand words Y₁ and Y₀ are loaded into PE 222 for processing, e.g., multiplication X₀·Y₁Y₀. (In some implementations, the multiplicand words Y₁ and Y₀ may first be loaded into a staging register of PE 222 prior to processing). During cycle 2, multiplier word X₂ is loaded into buffer PE 222, multiplier word X₃ is loaded into buffer of PE 224, multiplicand words Y₃ and Y₂ are loaded into PE 222, and multiplier word X₁ is moved from buffer of PE 224 to processing by PE 224 (multiplication X₁·Y₁Y₀). Similarly, during cycle 3, multiplier word X₂ is moved from buffer of PE 222 into PE 226, multiplier word X₃ is moved from buffer of PE 224 into buffer of PE 228, and multiplicand words Y₅ and Y₄ are loaded into PE 222. During cycle 4, multiplier word X₃ is moved from buffer of PE 228 to processing by PE 228 (multiplication X₃·Y₁Y₀), and so on. A similar loading sequence may be followed for other processing elements not shown in Table 1. As a result, multiplier words are delivered to every second processing element (e.g., PE 224, PE 228, etc.) one cycle before the words are used for multiplication (with buffers holding data for one cycle), whereas multiplier words are delivered to other processing elements (e.g., PE 222, PE 226, etc.) during the same cycle in which the words are used in multiplications.

Depicted with brackets, e.g., [X₀], [X₁], are multiplier words that may optionally be loaded as shown, as the corresponding values are not used by the respective (or subsequent) processing elements. For example, [X₀] may be loaded (e.g., for the uniformity of the data flow) or not loaded (for reduced power consumption) into buffer of PE 226 during cycle 2 with X₀ not used by PE 226 (or other downstream PEs). While Table 1 indicates one possible way of buffering data for gear ratio 1:2 operations, it should be understood that multiple other data management schemes may achieve similar functionality. For example, instead of using single-word buffers with every processing element, in some implementations, double-word buffers may be used with every second processing element (e.g., PE 224, PE 228, etc.).

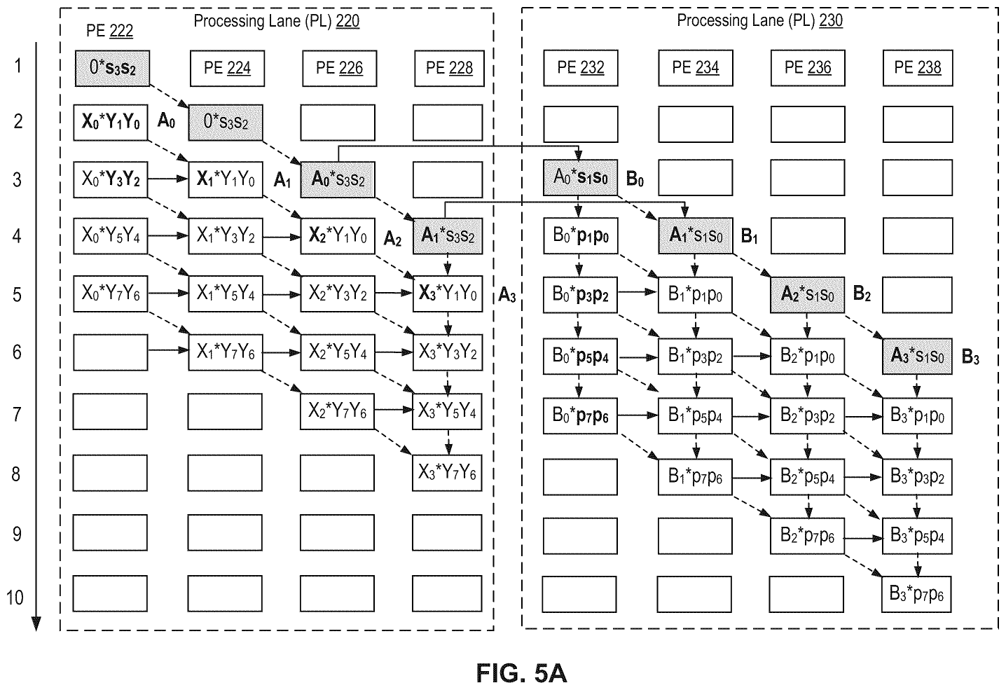

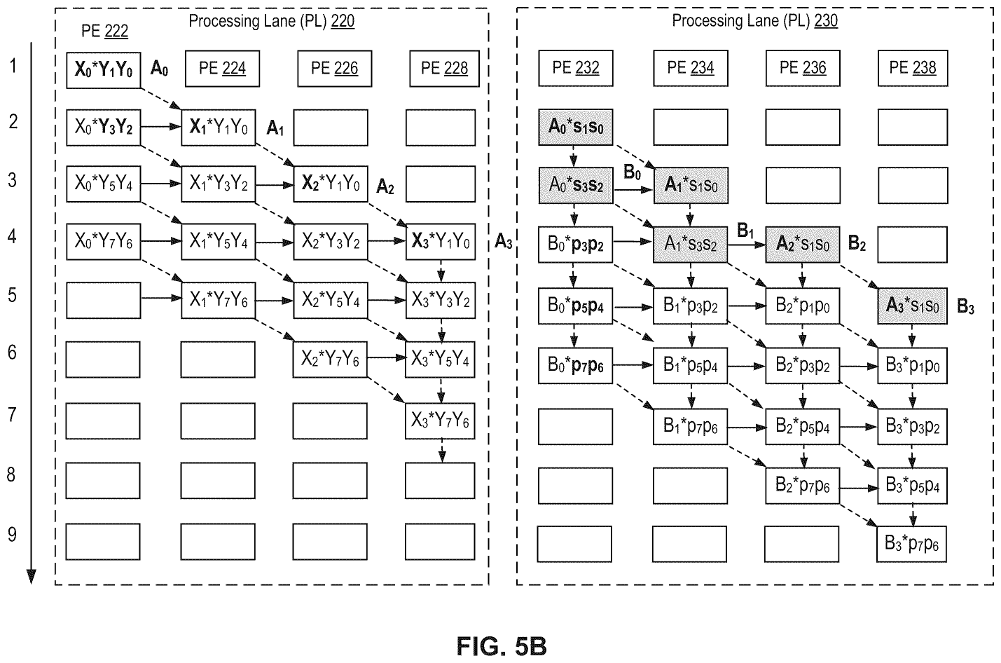

Computations performed by the processing lanes and processing elements illustrated in FIG. 4A and FIG. 4B may be modular operations defined on a ring of p elements (e.g., elements belonging to the interval of integers [0, p−1]). In some instances special primes p may be used, which have bit values 1 separated by at least the size of the word (minus one bit). Such instances allow reduction of accumulator values by a final PE that determines a respective last word of the result A=X·Y of a given significance. As a result, a modular reduction may be performed on a word-by-word basis and may not require additional processing by the cryptographic engine. In those instances where arbitrary moduli p are used, additional processing may be implemented for modular reduction, as described in more detail below. In some implementations, reduction X · Y mod p may be performed after multiplication X·Y is completed. In some implementations, reduction X·Y mod p may be performed while some of the computations of X·Y are still being carried out (as described below in conjunction with FIG. 5A and FIG. 5B).

Because computations modulo p require finding a remainder of a (computationally heavy) division operation, in some implementations a Montgomery reduction may be used. To find A=X·Y mod p, the multiplier X and the multiplicand Y can first be transformed into the Montgomery domain, X mod p→X̅=X·R mod p, B mod p→Y̅=Y·R mod p, using an auxiliary modulus (Montgomery radix) R that is coprime with p and often chosen to have a simple form (e.g., a power of the base number). Because of the presence of the extra factor R, the product X̅·Y̅ is not equal to the Montgomery representation Ā=X̅·̅Y̅ of the product X·Y as an extra division by R needs to be performed: Ā=X̅·Y̅·R⁻¹ mod p. To compute the product X̅·Y̅·R⁻¹ mod p without resorting to a division by p, the number (X̅·Y̅·s mod R)·p is first added to the product X̅·Y̅ (without changing its value mod p). Provided that the auxiliary number s is selected such that (R⁻¹ mod p)·R−ps=1, the sum X̅·Ý+(X̅·Y̅·s mod R)·p is certain to be an integer number of radix R. Division by R is then easily performed (e.g., by bit shifting) with the result being the Montgomery representation Ā of the product A=X·Y mod p (or, if the result exceeds p, Ā is obtained by one additional subtraction, Ā−p). For example, if p=89 and radix R=100, the inverse radix R⁻¹ mod p=81 and the auxiliary number s=91, so that 81·100−89·91=1. (The inverse radix and the auxiliary number can be precomputed and stored in memory for use with different input multipliers and multiplicands.) When multiplicand Y=47 (Y̅=4700 mod 89=72 in the Montgomery representation) is multiplied by X=19 (X̅=1900 mod 89=31), the number (X̅·Y̅·s mod R)·p=(19·47·91 mod 100)·89=7832 is added to X̅·Y̅=31·72=2232 and the sum X̅·Y̅+(X̅·Y̅·s mod R)·p=3300, after reduction by R=100 yields Ā=33, which is the correct Montgomery representation (Z̅=300 mod 89=33) of the number A=19·47 mod 89=3.

Using the Montgomery representation, any number of consecutive multiplications (and additions/subtractions) may be performed directly in the Montgomery domain without the need to perform any division operations (other than bit shifting) with only the final output transferred back from the Montgomery domain. Such a transformation may be performed as one additional Montgomery reduction.

FIG. 5A is a diagram illustrating one example implementation of a Montgomery reduction performed in connection with a multiplication operation by a cryptographic engine operating in accordance with some aspects of the present disclosure. Depicted in FIG. 5 are operations performed by processing elements of PL 220 and PL 230. Shown are consecutive cycles of computations, indicated with the numerals next to the vertical axis. Multiplications performed by various processing elements in consecutive cycles correspond to the same columns in FIG. 5A. For example, the left column in PL 230 box corresponds to operations of PE 232, and so on.

For the sake of illustration but not limitation, operations depicted in FIG. 5A involve processing of four m-bit words of multiplier X and eight m-bit words of multiplicand Y with one word of the multiplier multiplied each time by two words of the multiplicand (gear ratio 1:2), for example m=32 bits of the multiplier are multiplied by 2m=64 bits of the multiplicand. (A cryptographic engine may be configured to operate on words of any other bit sizes.) In the illustration of FIG. 5A, PL 220 computes a product of multiplier X and multiplicand Y while PL 230 perform Montgomery reduction of the computed product. More specifically, computations illustrated in FIG. 5A include computing, using PL 220, the product

$$A = X \cdot Y ,$$

in which both the multiplicand and the multiplier may be numbers in the Montgomery representation. (Bars over the letters, indicating the Montgomery representation, are being omitted for the sake of conciseness). Based on the computed product A, a reduction factor

$$B = A \cdot s mod R ,$$

is computed. As described in more detail below, computation of the reduction factor B may be split (for additional efficiency) between PL 220 and PL 230. (Multiplications used for determining words of B are depicted with shaded blocks.) Based on the computed reduction factor B, a product B·p is computed. Finally, an addition circuit (which may be a part of one of the processing elements, e.g., PE 238, or a separate addition circuit) computes the sum A+B·p and reduces the computed sum by radix R, e.g., by bit shifting, to remove the log₂ R least significant bits of the sum (which have value 0).

The operations involved in computations of the product A=X·Y are performed similarly to operations of FIG. 4A and FIG. 4B and are illustrated using similar notations. For example, the words that are loaded in conjunction with a respective multiplication operation are indicated with bolded letters inside the boxes and the multiplier/multiplicand words that are reused (passed between different PEs) are indicated with normal letters. To compute the reduction factor B=A·s mod R, it is sufficient to determine its log₂ R least significant bits (higher bits are eliminated by the mod R reduction). For the sake of illustration, it will be assumed that log₂ R is equal to the size (the number of bits) of the multiplier X. It should be understood, however, that in some implementations, log₂ R is larger than the size of the multiplier (e.g., by an integer number). In some implementations, R=2^{r}>p. The lowest four words of B are given by the six multiplications:

$$B mod {r}^{4} = {A}_{0} ( {s}_{0} + {s}_{1} r ) {r}^{0} + {A}_{1} ( {s}_{0} + {s}_{1} r ) {r}^{1} + {A}_{0} ( {s}_{2} + {s}_{3} {rr}^{2} + {A}_{2} ( {s}_{0} + {s}_{1} r ) {r}^{2} + {A}_{1} ( {s}_{2} + ) {r}^{3} + {A}_{3} ( {s}_{0} + ) {r}^{3} ,$$

where the words indicated by strikethroughs are inconsequential and may be omitted. For example, during computation of A₃·s₁s₀, the high word of the auxiliary number s need not be loaded (or a null word may be loaded) and the same multiplication may be performed as A₃·s₀.

In some implementations, all six multiplications in the computation of B mod r⁴ may be performed by PL 230. This may extend the total process of Montgomery reduction by an additional cycle. Also, in such implementations, PL 230 is performing significantly more computations (e.g., six multiplications) than PL 220. To enhance the uniformity of the flow of data, in some implementations (as depicted in FIG. 5A), computation of reduction factor B may be distributed between PL 220 and PL 230. Furthermore, such a distribution may be accomplished in a way that ensures that a specific word of B (e.g., B₀, B₁, etc.) is determined in a cycle that is preceding (e.g., immediately preceding) a cycle where the corresponding word of B is to be used. Additionally, the computation of the corresponding word of B may be completed by a processing element that is to use the corresponding word of B in the subsequent computations of the product B·p.

More specifically, the low word B₀ may be computed in two multiplications, A₀·s₁s₀ and A₀·s₃s₂ (e.g., as the low word of the sum of these two products). These two multiplications may be performed during a cycle (e.g., cycle 3) that is subsequent (e.g., immediately after) a cycle in which word A₀ is computed (e.g., cycle 2). As depicted, multiplication A₀·s₃s₂ may be performed by PL 220 while multiplication A₀·s₁s₀ may be performed by PL 230. Similarly, two multiplications, A₁·s₁s₀ and A₁·s₃s₂ that determine the next word B₁ may be performed in the cycle (e.g., cycle 4) that is after a cycle in which word A₁ is computed. Multiplication A₁·s₃s₂ may be performed by PL 220 while multiplication A₁·s₁s₀ may be performed by PL 230. As depicted, to facilitate passage of multiplicands between PEs within each processing lane, the four multiplications that have s₁s₀ as multiplicands may be performed by PL 230 while the two multiplications that have s₃s₂ as multiplicands may be performed by PL 220. Additionally, the multiplicand s₃s₂ may be loaded into PE 222 and passed through the PEs of PL 220, similarly to other multiplicands (e.g., Yⱼ₊₁Yⱼ and pⱼ₊₁pⱼ). The first two operations with the multiplicand s₃s₂ may be null multiplications: 0·s₃s₂. Some data may be passed between PL 220 and PL 230, e.g., accumulator value and carry obtained by PE 226 during computation of A₀·s₃s₂ may be passed to PE 232. Similarly, accumulator value and carry obtained by PE 228 during computation of A₁·s₃s₂ may be passed to PE 234, as depicted by the respective arrows.

The word B₀ is determined by PE 232 in cycle 3; the word B₁ is determined by PE 234 in cycle 4; the word B₂ is determined by PE 236 in cycle 5; and the word B₃ is determined by PE 238 in cycle 6. The determined words Bⱼ may be retained in the multiplier buffers of the respective PEs and used in the next (e.g., four) cycles with different multipliers pⱼ₊₁pⱼ of the modulus. The product B·p determined by PL 230 may then be added to the value A determined by PL 220 and the reduction modulo radix R may be perform (e.g., by bit shifting).

In some implementations, the multiplier X may be longer than four words (with each word representing a size of a portion of the multiplier that a processing element can handle per cycle), e.g., 4k, with some integer k>1. In such implementations, the multiplication operation may be performed in k iterations. In each iteration, four words of the multiplier may be processed, an accumulator value may be stored, and a Montgomery reduction (e.g., by R=2^{r} where r is the number of bits in the four words) may be performed. Each iteration may be performed by one PL (e.g., for special primes) or two PLs (e.g., for general primes), with the next iteration performed by the next one or two PLs, and so on.

FIG. 5B is a diagram illustrating another example implementation of a Montgomery reduction performed in connection with a multiplication operation by a cryptographic engine operating in accordance with some aspects of the present disclosure. Multiplications B₀·p₁p₀ and B₁·p₁p₀ affect only the low words of the product B·p, which are ultimately canceled when the sum A+B·p is computed (since the last four words of the sum are zero, per the Montgomery construction). Correspondingly, the multiplications B₀·p₁p₀ and B₁·p₁p₀ may be eliminated and replaced with the multiplications A₀·s₃s₂ and A₁·s₃s₂, as depicted in FIG. 5B. This replacement moves all operations related to the computation and use of the reduction factor B to PL 230.

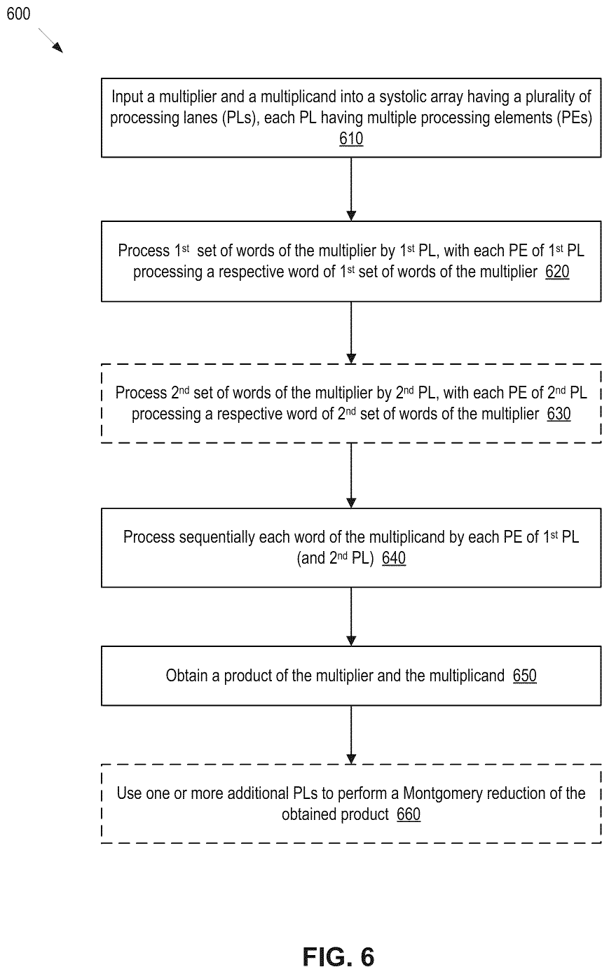

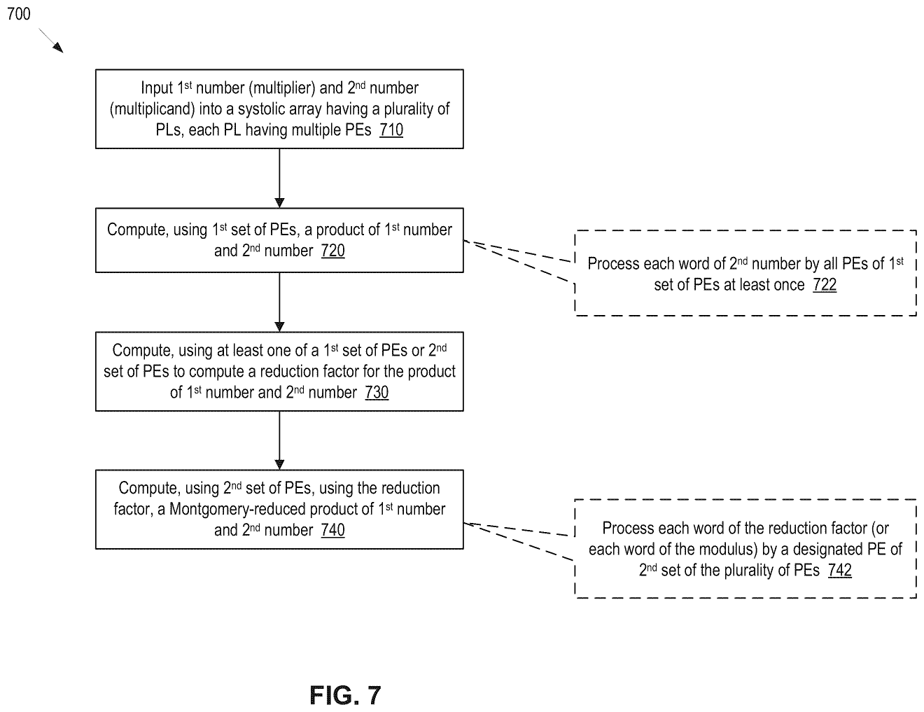

FIG. 6 and FIG. 7 are flow diagrams depicting illustrative methods 600 and 700 of using a cryptographic engine with a systolic array architecture in various computations, including but not limited to cryptographic computations. Methods 600 and 700 and/or each of their individual functions, routines, subroutines, or operations may be performed by a cryptographic engine (processor, accelerator), such as cryptographic engine 200 depicted in FIG. 2. Various blocks of methods 600 and 700 may be performed in a different order compared with the order shown in FIG. 6 and FIG. 7. Some blocks may be performed concurrently with other blocks. Some blocks may be optional. Methods 600, and 700 may be implemented as part of a cryptographic operation, which may involve a public key number and a private key number. The cryptographic operation may include RSA algorithm, an elliptic curve-based computation, or any other suitable operations.

A cryptographic engine or processor that performs methods 600 and 700 may include a systolic array having a plurality of processing lanes. In a systolic array, various data, such as operands (e.g., words of multiplier and multiplicand), accumulator values, carry values, and other lane outputs, may be passed along a direction that may be set by a control unit of the cryptographic processor, e.g., from PL 220 to PL 230, from PL 230 to PL 240, and from PL 240 to PL 250 (or vice versa), as shown in FIG. 2. In some implementations, each PL may be capable of providing, responsive to instructions from the control unit, a lane output to at least one other PL of the plurality of PLs. including providing an output of PL 250 to PL 220 (a circular systolic array). Each of the plurality of PLs may further include smaller processing elements (PE) that may be arranged in a systolic sub-array of two or more processing elements (PEs), e.g., PL 220 may include PEs 222-228. The systolic array may have any number of PLs, which in turn may include any number of PEs.

Each PE may be configured to multiply two numbers to obtain a multiplication product of the two numbers. In some implementations, the two numbers may include a 32-bit number and a 64-bit number, a 64-bit number and a 128-bit number, two 32-bit numbers, two 64-bit numbers, two 128-bit numbers, or any other suitable numbers. In some implementations, each PE may include an addition circuit (e.g., addition circuit 340 in FIG. 3) which may compute a sum of i) a multiplication product (obtained by the PE), ii) an input carry value, and iii) an input accumulator value. Each PE may further include a carry buffer (e.g., carry buffer 350) to store a high-bit portion of the computed sum and an accumulator buffer (e.g., accumulation buffer 360) configured to store a low-bit portion of the computed sum. In some implementations, at least some PEs may include a prime number unit configured to perform a modular reduction of the low-bit portion of the computed sum. The accumulator buffer and the carry buffer may be accessible to at least one other PE (e.g., a downstream PE). The accumulator value and the carry value may also be stored in a lane buffer (e.g., lane buffer 229 in FIG. 2) or in a memory unit (e.g., SRAM, scratchpad, flip-flop memory, etc.) of the cryptographic processor (or a memory unit accessible to the cryptographic processor). In some implementations, the lane buffer may store the lane output(s) for at least one computational cycle before providing the lane output(s) to a different PL (e.g., next downstream PL).

The control unit of the cryptographic processor may cause one or more input numbers to be selectively input into any of the plurality of PLs. For example, numbers X and Y may be input into PL 220 while numbers U and V may be input into PL 230. In some instances, numbers X and Y may be input into PL 220 and number U may be input into PL 230 while number Y is passed to PL 230 from PL 220. Similarly, the control unit may cause one or more output numbers to be selectively output by any of the plurality of PLs. For example, in some instances, the product X·Y may be output by PL 220 and stored in the memory. In other instances, the product X·Y may be passed to PL 230 for further processing, and in yet other instances, one part (e.g., a low word) of the product X·Y may be stored in the memory while another part (e.g., a high word) of the same product may be passed to PL 230 for further processing. In some implementations, the systolic array may include N PLs and may be configured (during performance of some tasks) to perform M parallel multiplication operations. More specifically, each set of N/M PLs may be performing a respective one of the M parallel multiplication operations.

FIG. 6 is a flow diagram depicting method 600 of a multiplication performed on a cryptographic processor that has a systolic array of processing elements and operates in accordance with one or more aspects of the present disclosure. At block 610, the cryptographic processor performing method 600 may cause a multiplier and a multiplicand to be input into the systolic array having a plurality of PLs. For example, a first PL may be configured to perform a first multiplication operation (e.g., X·Y) and a second PL of the plurality of PLs may be configured to perform a second multiplication operation (e.g., U·Y or U·V), as depicted in FIG. 4B. In some instances, at least one of the input numbers into the first multiplication operation (e.g., X) may be different from each of the input numbers into the second multiplication operation (e.g., U and V).

At block 620, method 600 may continue with processing a first set of words of the multiplier (e.g., X₀, X₁, X₂, X₃) using a first PL of the plurality of PLs, wherein each PE of the first PL is processing a respective word of the first set of words of the multiplier. For example, PE 222 in FIG. 4A is processing word X₀, PE 224 is processing word X₁, and so on. At block 630, method 600 may optionally (as depicted with the dashed box) include processing a second set of words of the multiplier (e.g., X₄, X₅, X₆, X₇) using a second PL (e.g., PL 230 in FIG. 4A). Each PE of the second PL may be processing a respective word of the second set of words of the multiplier. For example, PE 232 in FIG. 4A is processing word X₄, PE 234 is processing word X₅, and so on. As illustrated in FIG. 4A, such processing by the first PL and the second PL may be performed during a joint multiplication operation. For example, as illustrated in FIG. 4A, PL 220 and PL 230 are performing a joint multiplication that involves a multiplier X having eight words (e.g., more than the number of PEs in a single lane). As depicted with solid and dashed arrows in FIG. 4A, during performance of the joint multiplication operation, a data may be transferred between the first PL (e.g., PL 220) and the second PL (e.g., PL 230); the transferred data may include multiplicand data (e.g., multiplicand words), accumulator data, carry data, etc., or any combination thereof. In some implementations, during performance of the joint multiplication operation, all multiplications involving a first word of the multiplier (e.g., X₀) may be performed by a first PE (e.g., PE 222) of a first PL (e.g., PL 220), all multiplications involving a second word of the multiplier (e.g., X₁) may be performed by a second PE (e.g., PE 222) of a first PL (e.g., PL 220), and so on. During performance of some joint multiplication operations (e.g., with a large number of multiplier words), all PEs of all PLs may be performing a respective share of computations. For example, all four PLs 220-250 may be deployed to perform a multiplication operation on a multiplier having sixteen multiplier words (X₀ . . . X₁₅). In such instances, multiplications involving a first word of the multiplier (e.g., X₀) may be performed by a first PE (e.g., PE 222) of a first PL (e.g., PL 220) while all multiplications involving a last word of the multiplier (e.g., X₁₅) are performed by a last PE (e.g., PE 258) of a last PL (e.g., PL 250).

At block 640 method 600 may include processing sequentially each word of the multiplicand by each PE of the first PL. For example, as illustrated in FIG. 4B, each word Yⱼ of the multiplicand is processed by each PE of PL 220. Likewise, during performance of the joint multiplication operation, each word of the multiplicand may also be sequentially processed by all PEs of the second PL. For example, as illustrated in FIG. 4A, each word Yⱼ of the multiplicand is also processed by each PE of PL 230.

At block 650, method 600 may continue with obtaining, based on the processing of the first set of words (e.g., X₀, X₁, X₂, X₃) of the multiplier by the first PL and the processing of each word Yⱼ of the multiplicand by the first PL, a product of the multiplier and the multiplicand. In the instances of the joint multiplication operations, obtaining the product of the multiplier and the multiplicand may be further based on the processing of the second set of words (e.g., X₄, X₅, X₆, X₇) of the multiplier by the second PL and the processing of each word Yⱼ of the multiplicand by the second PL. The product of the multiplier and the multiplicand may be represented with a set of accumulator words (e.g., A₀, A₁, . . . ) determined by various PLs and PEs.

In some implementations, at optional block 660, method 600 may include performing a Montgomery reduction of the obtained product of the multiplier and the multiplicand. For example, in those instances where a first subset of PLs (which may include one or more PLs) performed a multiplication operation (e.g., in conjunction with blocks 610-650), a second subset of PLs may perform the Montgomery reduction (or any other suitable way of performing a modular reduction) of the obtained product number. For example, PLs 220 and 230 may obtain a product of an eight-word multiplier X and a multiplicand Y (of an arbitrary length) and PLs 240 and 250 may determine a Montgomery-reduced value of the obtained product.

FIG. 7 is a flow diagram depicting method 700 of a Montgomery reduction performed on a cryptographic processor that has a systolic array of processing elements and operates in accordance with one or more aspects of the present disclosure. At block 710, method 700 may include inputting a first number (e.g., multiplier X) and a second number (e.g., multiplicand Y) into a systolic array having a plurality of PLs, each PL including a sub-array of two or more PEs. Each of the PEs may be configured to perform a multiplication operation, e.g., multiply a word of the first number and a word of the second number. At block 720, method 700 may continue with computing the product of the first number and the second number (e.g., A=X·Y). In some implementations, as illustrated with callout box 722, during computation of the product of the first number and the second number, each PE of the first set of the plurality of PEs (e.g., PL 220 in FIG. 5A or FIG. 5B) may be processing all words of the second number (e.g., Y) at least once. At block 730, method 700 may continue with computing, using at least one of the first set (e.g., PL 220) of the plurality of PEs or a second set (e.g., PL 230) of the plurality of PEs to compute a reduction factor (e.g., reduction factor B) for the product of the first number and the second number. In some implementations, as depicted in FIG. 5A, a first portion of computations (e.g., multiplications Aⱼ·s₃s₂) of the reduction factor may be performed by the first set of the plurality of PEs and a second portion of computations (e.g., multiplications Aⱼ·s₁s₀) of the reduction factor may be computed by the second set of the plurality of PEs. In other implementations, the reduction factor may be computed by the second set of the plurality of PEs (e.g., as depicted in FIG. 5B where the multiplications Aⱼ·s₃s₂ and the multiplications Aⱼ·s₁s₀ are performed by PL 230).

Method 700 may continue, at block 740, with computing, using the reduction factor, a Montgomery-reduced product of the first number and the second number. For example, the product of the first number and the second number (e.g., A) may be added to the product of the reduction factor times a modulus number p and reduced by a Montgomery radix R: (A+B·p)/R. In some implementations, as illustrated with callout box 742, during computation of the Montgomery-reduced product of the first number and the second number, each word of the reduction factor (e.g., B) or each word of a modulus number (e.g., p) may be processed by a designated, for a respective word, PE of the second set of the plurality of PEs (e.g., PL 230). For example, as depicted in FIG. 5A and FIG. 5B, each word of the reduction factor, e.g., B₀, B₁, B₂, and B₃, is processed by a designated PE of PL 230, e.g., PE 232 (word B₀), PE 234 (word B₁), PE 236 (word B₂), and PE 238 (word B₃), respectively. In other implementations, the reduction factor B and the modulus number p may be interchanged (since B·p=p·B) so that PE 232 processes word p₀ of the reduction factor, PE 234 processes word p₁ of the reduction factor, and so on.

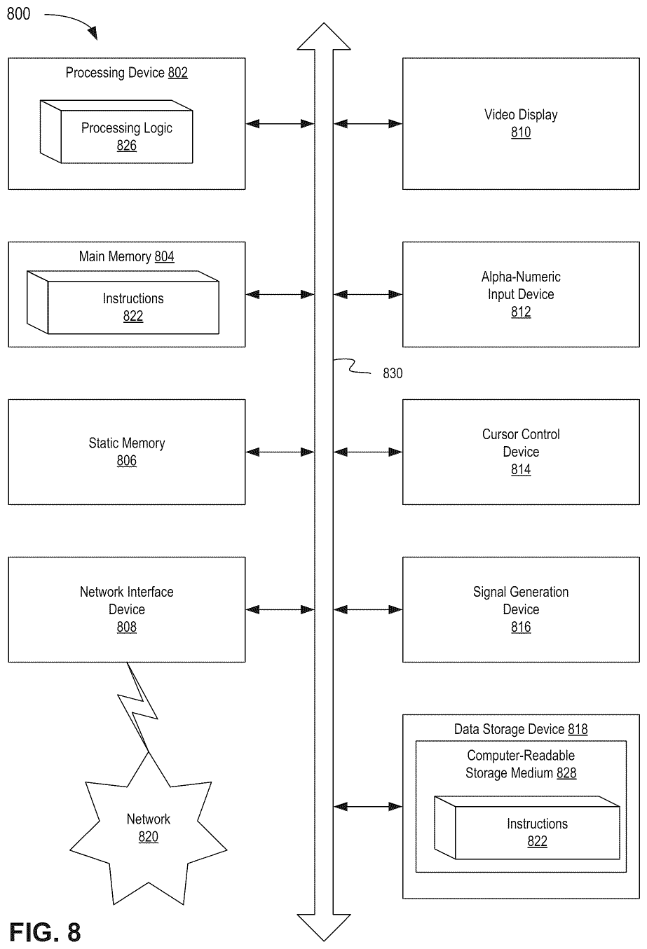

FIG. 8 depicts a block diagram of an example computer system 800 operating in accordance with one or more aspects of the present disclosure. In various illustrative examples, example computer system 800 may be computer system 102, illustrated in FIG. 1. Example computer system 800 may be connected to other computer systems in a LAN, an intranet, an extranet, and/or the Internet. Computer system 800 may operate in the capacity of a server in a client-server network environment. Computer system 800 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 800 may include a processing device 802 (also referred to as a processor or CPU), a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.), and a secondary memory (e.g., a data storage device 818), which may communicate with each other via a bus 830.

Processing device 802 represents one or more general-purpose processing devices such as a microprocessor, central processing unit, or the like. More particularly, processing device 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 802 may be configured to execute instructions facilitating implementation of method 600 of a multiplication and method 700 of a Montgomery reduction performed on a cryptographic processor that operates in accordance with one or more aspects of the present disclosure.

Example computer system 800 may further comprise a network interface device 808, which may be communicatively coupled to a network 820. Example computer system 800 may further comprise a video display 810 (e.g., a liquid crystal display (LCD), a touch screen, or a cathode ray tube (CRT)), an alphanumeric input device 812 (e.g., a keyboard), a cursor control device 814 (e.g., a mouse), and an acoustic signal generation device 816 (e.g., a speaker).

Data storage device 818 may include a computer-readable storage medium (or, more specifically, a non-transitory computer-readable storage medium) 828 on which is stored one or more sets of executable instructions 822. In accordance with one or more aspects of the present disclosure, executable instructions 822 may comprise executable instructions implementing method 600 of a multiplication and method 700 of a Montgomery reduction performed on a cryptographic processor that operates as described above.

Executable instructions 822 may also reside, completely or at least partially, within main memory 804 and/or within processing device 802 during execution thereof by example computer system 800, main memory 804 and processing device 802 also constituting computer-readable storage media. Executable instructions 822 may further be transmitted or received over a network via network interface device 808.

While the computer-readable storage medium 828 is shown in FIG. 8 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMS, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A cryptographic processor comprising:
a systolic array comprising a plurality of processing lanes (PLs), each of the plurality of PLs comprising a systolic sub-array of two or more processing elements (PEs), wherein each PE is configured to:
multiply two numbers to obtain a multiplication product; and
store an accumulator value of the obtained multiplication product in at least one of:
an accumulator buffer accessible to at least one other PE, or
a memory unit for the cryptographic processor; and
a control unit configured to:
cause one or more input numbers to be selectively input into any of the plurality of PLs; and
cause one or more output numbers to be selectively output by any of the plurality of PLs.

2. The cryptographic processor of claim 1, wherein a first PL of the plurality of PLs is configured to perform a first multiplication operation and a second PL of the plurality of PLs is configured to perform a second multiplication operation, and wherein at least one of the input numbers into the first multiplication operation is different from each of the input numbers into the second multiplication operation.

3. The cryptographic processor of claim 1, wherein a first PL of the plurality of PLs and a second PL of the plurality of PLs are to perform a joint multiplication operation, and wherein during performance of the joint multiplication operation a data is transferred between the first PL and the second PL, the transferred data comprising at least one of multiplicand data, accumulator data, or carry data.

4. The cryptographic processor of claim 1, wherein all PLs of the plurality of PLs are to perform a joint multiplication operation on a multiplier and a multiplicand, and wherein during performance of the joint multiplication operation all multiplications involving a first word of the multiplier are performed by a first PE of a first PL of the plurality of PLs and all multiplications involving a last word of the multiplier are performed by a last PE of a last PL of the plurality of PLs.

5. The cryptographic processor of claim 4, wherein during performance of the joint multiplication operation each word of the multiplicand is processed by all PEs at least once.

6. The cryptographic processor of claim 1, wherein a first subset of the plurality of PLs is to perform a multiplication operation to obtain a product number and a second subset of the plurality of PLs is to perform a modular reduction of the obtained product number.

7. The cryptographic processor of claim 6, wherein the modular reduction comprises a Montgomery reduction of the obtained product number.

8. The cryptographic processor of claim 1, wherein the plurality of PLs comprises N PLs and is configured to perform M parallel multiplication operations, wherein each set of N/M PLs is to perform a respective one of the M parallel multiplication operations.

9. The cryptographic processor of claim 1, wherein the two numbers comprise a 32-bit number and a 64-bit number.

10. The cryptographic processor of claim 1, wherein at least some of the plurality of PLs comprise a buffer to store a lane output of a respective PL for at least one computational cycle before providing the lane output to a different PL of the plurality of PLs.

11. The cryptographic processor of claim 1, wherein each PL of the plurality of PLs is capable of providing, responsive to instructions from the control unit, a lane output to at least one other PL of the plurality of PLs.

12. The cryptographic processor of claim 1, wherein each PE comprises:
a multiplication circuit configured to multiply the two numbers to obtain the multiplication product;
an addition circuit configured to compute a sum of i) the obtained multiplication product, ii) an input carry value, and iii) an input accumulator value;
the accumulator buffer configured to store a low-bit portion of the computed sum; and
a carry buffer to store a high-bit portion of the computed sum.

13. The cryptographic processor of claim 12, wherein at least one PE of each PL further comprises:
a prime number unit configured to perform a modular reduction of the low-bit portion of the computed sum.

14. A cryptographic processor configured to perform a Montgomery reduction of a product of a first number and a second number, the cryptographic processor comprising:
a systolic array comprising a plurality of processing elements (PEs), each of the PEs configured to perform a multiplication operation; and
a control unit configured to:
cause a first set of the plurality of PEs to compute the product of the first number and the second number;
cause at least one of a first set of the plurality of PEs or a second set of the plurality of PEs to compute a reduction factor for the product of the first number and the second number; and
cause the second set of the plurality of PEs to compute, using the reduction factor, a Montgomery-reduced product of the first number and the second number.

15. The cryptographic processor of claim 14, wherein a first portion of computations of the reduction factor is performed by the first set of the plurality of PEs and a second portion of computations of the reduction factor is computed by the second set of the plurality of PEs.

16. The cryptographic processor of claim 14, wherein the reduction factor is computed by the second set of the plurality of PEs.

17. The cryptographic processor of claim 14, wherein,
during computation of the product of the first number and the second number, each PE of the first set of the plurality of PEs is processing all words of the second number at least once; and
during computation of the Montgomery-reduced product of the first number and the second number, each word of the reduction factor or each word of a modulus number is processed by a designated, for a respective word, PE of the second set of the plurality of PEs.

18. A method comprising:
inputting a multiplier and a multiplicand into a systolic array comprising a plurality of processing lanes (PLs), each of the plurality of PLs comprising a systolic sub-array of two or more processing elements (PEs), wherein each PE is configured to perform a multiplication of a word of the multiplier and a word of the multiplicand;
processing a first set of words of the multiplier using a first PL of the plurality of PLs, wherein each PE of the first PL is processing a respective word of the first set of words of the multiplier;
processing sequentially each word of the multiplicand by each PE of the first PL; and
obtaining, based on the processing of the first set of words of the multiplier by the first PL and the processing of each word of the multiplicand by the first PL, a product of the multiplier and the multiplicand.

19. The method of claim 18, further comprising:
processing a second set of words of the multiplier using a second PL of the plurality of PLs, wherein each PE of the second PL is processing a respective word of the second set of words of the multiplier, and
processing sequentially each word of the multiplicand by each PE of the second PL, and wherein obtaining the product of the multiplier and the multiplicand is further based on the processing of the second set of words of the multiplier by the second PL and the processing of each word of the multiplicand by the second PL.

20. The method of claim 18, further comprising:
using a second PL of the plurality of PLs to perform a Montgomery reduction of the obtained product of the multiplier and the multiplicand.
